(19) United States
(12) Patent Application Publication
(10) Pub. No.: US 2013/0008713 A1
(43) Pub. Date: Jan. 10, 2013

(54) CONNECTOR SUPPORTING TOOL, WIRING TOOL AND WIRING HARNESS

(75) Inventors: Ryosuke Fujioka, Yokkaichi-City (JP); Yoshiaki Yamano, Yokkaichi-City (JP); Atsushi Kasamatsu, Yokkaichi-City (JP); Hiroshi Yamashita, Yokkaichi-City (JP)

(73) Assignees: AUTONETWORKS TECHNOLOGIES, LTD., Yokkaichi-City (JP); SUMITOMO ELECTRIC INDUSTRIES, LTD., Osaka (JP); SUMITOMO WIRING SYSTEMS, LTD., Yokkaichi-City (JP)

(21) Appl. No.: 13/535,415

(22) Filed: Jun. 28, 2012

(30) Foreign Application Priority Data
Jul. 5, 2011 (JP) 2011-148806

(51) Int. Cl. H02G 3/04; H01B 7/00

(52) U.S. Cl. 174/72 A; 174/135

(57) ABSTRACT

A wiring tool for holding wires has a plate-like member with connector support (15) that supports a connector (91) by engaging a coupling portion (92) of the connector (91). The connector support (15) has two parallel recesses (151) that form parallel grooves extending straight in from an outer edge of the plate-like member. Two parallel projections (921) of the coupling (92) are fit into the grooves. An intermediate plate (152) of the connector support (15) is between the parallel recesses (151) and is inserted into a clearance between the outer surface of the connector (91) and a beam (922) of the coupling (92). The intermediate plate (152) has a hole (153) that engages a facing projection (923) formed on the beam (922).

### BACKGROUND OF THE INVENTION

1. Field of the Invention

The invention relates to a connector supporting tool for supporting a connector, a wiring tool for holding connector connected wires in predetermined shapes and a wiring harness including the same.

2. Description of the Related Art

A wiring harness mounted in a vehicle, such as an automotive vehicle, may include a wiring tool made of resin. The wiring tool is attached to wires and is laid with the wires held along paths predetermined by the wiring tool. For example, wires in a conventional wiring harness may be fixed to a plate-like or bar-like resin member by a binding member, such as an adhesive tape or a belt to hold the wires in predetermined shapes.

Japanese Unexamined Patent Publication No. 2010-27242 discloses a wiring harness with a wiring tool composed of a plate-like resin base and a plate-like resin cover fixed together by heat pressing while sandwiching a wire bundle. A rib stands up from the base and is inserted into a through hole in the cover when the cover is placed on the base. Intermediate parts of the wires are sandwiched between the base and the cover and connectors mounted on ends of some wires are fixed to an edge of the base. Other wires extend from the base to the outside of the base and a binding member binds parts of these wires to an eave on an outer edge of the base.

The wiring harness should be shaped so that respective wires are fixed at predetermined reference positions near connection partners, such as wiring devices or connectors provided on ends of other wires.

For example, connectors on wires of a wiring harness that is to be arranged below a seat of an automotive vehicle should be near the connectors at predetermined reference positions so that the connectors on the wires of the wiring harness reach devices, such as a motor for driving the seat or connectors of other wires in just proportion.

Japanese Unexamined Patent Publication No. H08-195253 discloses a connector mounting clamp for fixing a connector to a supporting body, such as a panel of an automotive vehicle. The connector mounting clamp is a unitary resin member having a part to be coupled with a coupling formed on the connector and a clamp to be fixed to the supporting body by engaging an edge of a hole of the supporting body. This connector mounting clamp enables the connector on the ends of the wires to be fixed easily at a predetermined position on the supporting body, such as a panel of an automotive vehicle.

The connector mounting clamp of Japanese Unexamined Patent Publication No. H08-195253 has a relatively complicated three-dimensional shape and requires an injection molding process using a slide mold. Accordingly, the connector mounting clamp disclosed in Japanese Unexamined Patent Publication No. H08-195253 has a problem of relatively many man-hours and high cost required for production.

Further, one connector mounting clamp disclosed in Japanese Unexamined Patent Publication No. H08-195253 is necessary for each connector. Thus, in the case of fixing plural connectors on plural wires of a wiring harness, the number of parts increases and man-hours for parts management and time required for an operation of individually fixing plural connectors to a supporting body via connector mounting clamps drastically increase.

Plural connectors could be fixed at predetermined positions near the outer edge of the wiring tool in the wiring harness disclosed in Japanese Unexamined Patent Publication No. 2010-27242. However, attaching the wiring harness to a supporting body, such as a panel of an automotive vehicle, requires an fixing the wiring tool to the supporting body using clamps and fixing each of the connectors to the supporting body using connector mounting clamps. Such operations are very cumbersome.

Japanese Unexamined Patent Publication No. 2010-27242 discloses that the connectors are fastened temporarily to the base. However, a specific structure for fixing the connectors to the base is not shown.

Objects of the invention are to provide a wiring tool for holding wires in a wiring harness in specified shapes while protecting the wires and to provide a connector supporting tool for a wiring tool to reduce time required for fixing connectors provided on the wires while reducing man-hours and production costs.

### SUMMARY OF THE INVENTION

The invention relates to a connector supporting tool for supporting a connector mounted on an end of at least one wire. Two projections project from an outer surface of the connector and extend substantially straight and parallel to one another. A beam is formed at a distance from the outer surface of the connector between the projections and a facing projection projects from the beam toward the outer surface of the connector. The connector supporting tool has at least one connector support with two parallel grooves that extend substantially straight in from an outer edge of the connector supporting tool. The parallel projections of the coupling of the connector fit into the grooves. An intermediate plate is between the parallel grooves and has a hole or recess that receives the facing projection when the intermediate plate is inserted into a clearance between the outer surface of the connector and the beam of the coupling.

The connector supporting tool may comprise a plate with one or more projections and one or more recesses. The parallel grooves preferably extend substantially straight in from the outer edge of the plate.

The invention also relates to a connector to be supported by the above-described connector supporting tool. The connector has the above-described coupling with two straight parallel projections, a beam and a facing projection. The projections project from the outer surface of the connector. The beam is spaced from the outer surface of the connector and is between the projections. The facing projection projects from the beam toward the outer surface of the connector. The connector supporting tool supports the connector by engaging the coupling of the connector.

The connector supporting tool with projections and recesses may be formed by applying vacuum forming to a flat resin plate.

The invention also relates to a wiring tool, comprising a plate-like member for holding one or more wires in specified shapes and having at least one connector mounted on ends of the wires. The connector is formed with the above-described coupling. The plate-like member has one or more projections and one or more recesses and includes a wiring portion that substantially faces a wiring space where the one or more wires are to be arranged. At least one frame is formed at the outer side of the wiring portion and forms an outer edge of the plate-like member. The above-described connector support is formed on a part of the frame and a can be fixed to the above-described connector in the manner described above.

The invention also relates to a wiring harness comprising the above-described wiring tool and one or more wires having at least one connector mounted on ends thereof and connected to the connector support of the wiring tool.

The above-described connector supporting tool has a plate with projections, recesses and grooves formed in parts thereof. This member is obtained by applying vacuum forming to a flat resin plate or by injection molding using a simple mold including no sliding mechanism, and man-hours and cost required for production are small.

The plural connector supports on one wiring tool enables plural connectors to be fixed at one time at specified positions of a supporting body, such as a panel of an automotive vehicle, merely by attaching one wiring tool to the supporting body. Thus, the time required for fixing connectors on wires at predetermined positions can be reduced.

The respective boundary parts between the sides of the intermediate plate and the parallel recesses preferably are cut inward. Thus the intermediate plate engages the beam in the coupling of the connector in a more stable state and makes the connector less likely to separate from the connector supporting tool.

The inner recess that connects the pair of grooves preferably is formed in the connector supporting tool because the rigidity of the connector supporting tool that is a plate-like member with projections and recesses is increased.

Members obtained by applying vacuum forming to a flat plate generally can be produced more easily and at lower cost than members obtained by resin injection molding. Thus, forming the above-described connector supporting tool by applying vacuum forming to a flat plate reduces production man-hours and cost. Note that the base including the rib disclosed in Japanese Unexamined Patent Publication No. 2010-27242 and the connector mounting clamp disclosed in Japanese Unexamined Patent Publication No. H08-195253 cannot be obtained by applying vacuum forming to a flat plate.

The connector on the ends of the wires is held at a fixed position by being supported by the connector support of the above-described wiring tool. That is, the shapes of the wires are held by the wiring tool so that the connector on the ends of the wires reaches a connection partner in just proportion. Further, the connector is fixed at a predetermined position on a supporting body merely by attaching the wiring tool attached to connector connected wires to the supporting body by clamps or the like. That is, the above-described wiring tool simplifies an operation of fixing the connector at the predetermined position on the supporting body particularly if plural connector supporting portions are provided on the wiring tool.

These and other objects, features and advantages of the present invention will become more apparent upon reading of the following detailed description of preferred embodiments and accompanying drawings. It should be understood that even though embodiments are separately described, single features thereof may be combined to additional embodiments.

### BRIEF DESCRIPTION OF THE DRAWINGS

FIG. 1 is a perspective view of a wiring tool 10 according to an embodiment of the invention.

FIG. 2 is a view with hatching indicating area partitioning in the perspective view of the wiring tool 10.

FIG. 3 is a perspective view of a wiring harness 100 of the invention.

FIG. 4 is a perspective view of the wiring tool 10 and wires 9.

FIG. 5 is a partial section of the wiring harness 100.

FIG. 6 is a perspective view showing a state where wires and a binding belt are fixed to a wire binding portion of the wiring tool.

FIG. 7 is a front view of the wire binding portion to which the wires are fixed.

FIG. 8 is a perspective view of a connector supporting portion of the wiring tool.

FIG. 9 is a perspective view of a connector on ends of wires.

FIG. 10 is a front view in section of the connector supporting portion to which the connector is fixed.

FIG. 11 is a perspective view showing the basic structure of the connector supporting portion in the wiring tool 10.

FIG. 12 is a perspective view showing the basic structure of the connector that can be supported by the connector supporting portion of the wiring tool 10.

FIG. 13 is a perspective view of a connector supporting tool 10A according to an embodiment of the present invention.

FIG. 14 is a front view of the connector supporting tool 10A being attached to a supporting body.

FIG. 15 is a perspective view of a connector supporting portion and a connector according to a reference example.

### DETAILED DESCRIPTION OF THE PREFERRED EMBODIMENTS

A particular embodiment of the invention is described with reference to the accompanying drawings. The following embodiment is a specific example of the invention and does not limit the scope of the invention.

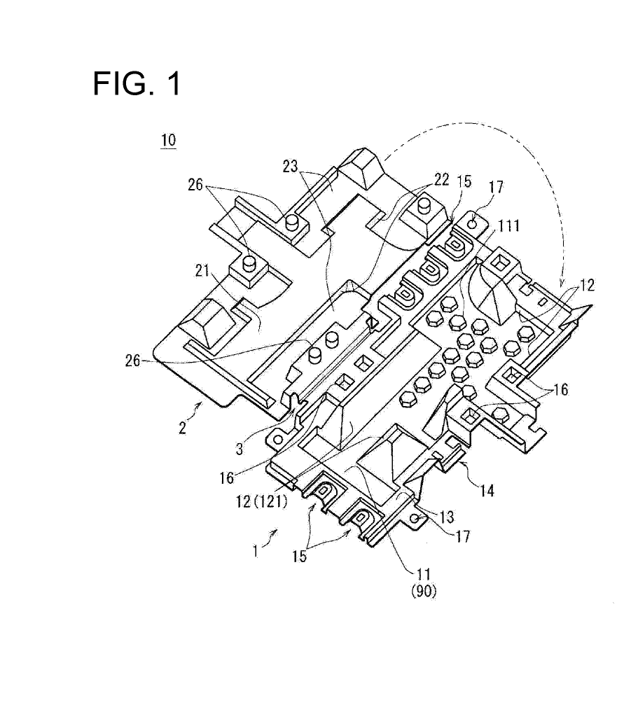

The invention includes a wiring tool 10 and a wiring harness 100 as shown in FIGS. 1 to 5. The wiring harness 100 includes a wire set comprising plural wires 9 and the wiring tool 10 attached to the wire set. The wiring harness 100 is to be mounted, for example, in a space below a seat, a space under the roof or in the trunk of a vehicle and is connected to other wires and/or wiring devices. The wires 9 of the wiring harness 100 are connector-connected wires composed of insulated wires and a connector 91 mounted on ends of the insulated wires.

The wires 9 of the wiring harness 100 are united by the wiring tool 10 while being held in specified shapes. Thus, the wiring harness 100 can be mounted easily at a predetermined position using a fixing device, such as a clamp.

In this embodiment, the wiring tool 10 is obtained by applying vacuum forming to a resin plate formed from a resin such as polypropylene (PP), polyethylene (PE), polyvinylchloride (PVC), polyethylene terephthalate (PET) and/or polyamide (PA).

Members obtained by applying vacuum forming to a flat plate can be produced more easily and at lower cost than members obtained by resin injection molding. Thus, production time and production cost are reduced for the wiring tool 10 obtained by applying vacuum forming to a flat plate.

As shown in FIG. 1, the wiring tool 10 includes a base 1, a cover 2 to be placed on the base 1 and a connecting portion 3 extending unitarily between the base 1 and the cover 2. The connecting portion 3 is a resiliently bendable hinge. The cover 2 is assembled with the base 1 while sandwiching intermediate parts of the wires 9 between the base 1 and the cover 2.

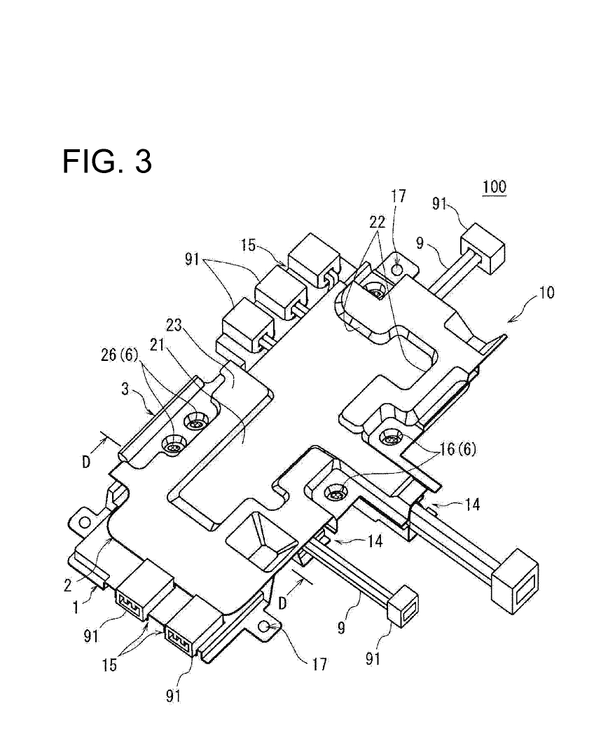

As shown in FIG. 3, the wiring tool 10 is folded, bent or deformed at the connecting portion 3 by bending the connecting portion 3 to place the cover 2 on the base 1. The base 1 and the cover 2 are to be fixed while sandwiching the wires 9 therebetween so that the wiring tool 10 holds the wires 9 sandwiched between the base 1 and the cover 2 in specified shapes.

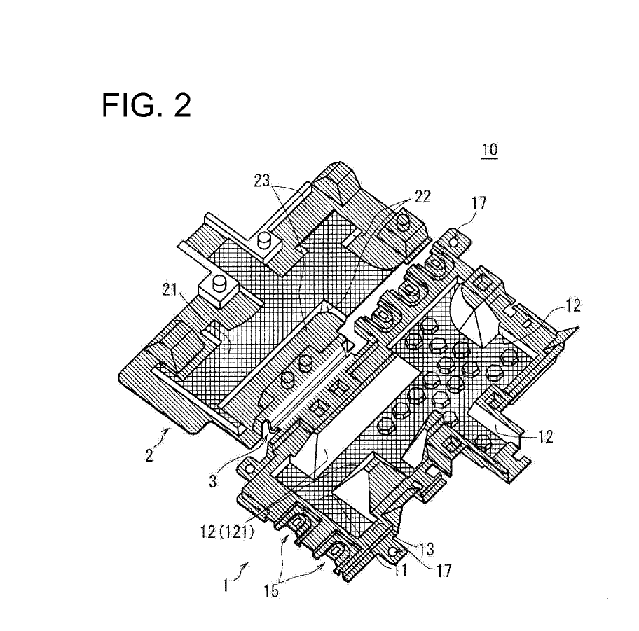

The base 1 of the wiring tool 10 is a resin plate with projections and recesses. As described above, the base 1 in this embodiment is obtained by applying vacuum forming to an initially flat resin plate. As shown in FIGS. 1 and 2, the base 1 includes a wiring portion 11, a first step 12 and a first frame 13.

The cross-hatched area of the base 1 in the perspective view shown in FIG. 2 is an area of the wiring portion 11 and a diagonally hatched area is an area of the first frame 13. The first step 12 is formed to be continuous with the outer periphery of the wiring portion 11 and the inner periphery of the first frame 13.

The wiring portion 11 of the base 1 is a substantially is a plate-like part facing a wiring space 90 where the wires 9 are to be arranged. No partition for partitioning the wiring space 90 is formed on the wiring portion 11. Projections 111 are formed in a relatively wide area of the wiring portion 11 for reinforcement. The projections 111 have heights equal to or lower than the height of the first step 12. The wiring portion 11 also can be called a bottom or base plate and forms the bottom surface of the base 1.

The projections 111 formed on the wiring portion 11 are hollow parts with convex surfaces raised toward the wiring space 90. In the example shown in FIG. 1, each projection 111 has a truncated pyramid shape extending from the bottom surface and with a planar top surface substantially parallel to the bottom surface. The projections 111 may have other shapes, for example, cylinders, hemispheres or truncated cones.

The first step 12 of the base 1 is formed substantially along the outer edge of the wiring portion 11 and stands from the wiring portion 1 toward the wiring space 90 to form a step. Thus, the outer periphery of the wiring portion 11 is formed along the inner periphery of the first step 12. The surface of the first step 12 in this embodiment is inclined out from the periphery of the wiring portion 11.

In the example shown in FIG. 1, the first step 12 does not have a constant height in its entirety, but has elevated steps 121 formed to be higher than other parts. The first step 12 has a height at least substantially equal to or higher than the height of the projections 111 of the wiring portion 11.

The first frame 13 of the base 1 is formed along the outer periphery of the first step 12 and forms an outer edge of the base 1. The first frame 13 comprises a flat plate interrupted in the illustrated embodiment by recesses and projections.

The first frame 13 further includes wire binding portions 14, connector supports 15 and temporary fastening recesses 16, as shown in FIG. 1. The wire binding portions 14 and the connector supports 15 are parts for fixing the wires 9 arranged from the wiring portion 11 to the first frame 13.

Clamp holes 17 are formed through the first frame 13 of the base 1 and can receive fixing members (such as clamps, straps, rivets and/or bolts) for mounting the wiring tool 10 on a supporting body, such as a panel of an automotive vehicle. The wiring tool 10 is fixed to the supporting body by passing the fixing members (e.g. clamps) through the clamp holes 17 of the base 1 and into mounting holes in the supporting body.

The cover 2 of the wiring tool 10 is a resin plate with projections and recesses. As described above, the cover 2 in this embodiment is obtained by applying vacuum forming to a flat resin plate together with the base 1. As shown in FIGS. 1 and 2, the cover 2 includes a facing wall 21, a second step 22 and a second frame 23. The cover 2 also has temporary fastening projections 26 at the outer side of the second frame 23.

The cross-hatched area in the cover 2 in the perspective view shown in FIG. 2 is the facing wall 21 and the diagonally hatched area is the second frame 23. The second step 22 is substantially continuous with the outer periphery of the facing wall 21 and the inner periphery of the second frame 23.

Note that a state of the cover 2 placed on and assembled with the base 1 is assumed when the positions or shapes of the elements of the cover 2 are described below in relation to the base 1.

As shown in FIG. 5, the facing wall 21 of the cover 2 faces the wiring portion 11 of the base 1 across the wiring space 90. No partition is formed on the facing wall 21 for partitioning the wiring space 90 and the facing wall 21 in this embodiment is a substantially flat plate in its entirety. However, projections similar to the projections 111 of the wiring portion 11 of the base 1 may be formed on the facing wall 21.

The second step 22 of the cover 2 is formed along the outer periphery of the facing wall 21 and stands from the facing wall 21 in a direction away from the base 1. Thus, the outer periphery of the facing wall 21 is formed along the inner periphery of the second step 22. The second step 22 in this embodiment inclines out from the edge of the facing wall 21. In the example shown in FIG. 1, the second step 22 has a substantially constant height in its entirety. However, the second step 22 may have parts formed higher than other parts.

The second frame 23 of the cover 2 is formed along the outer periphery of the second step 22 and forms an outer edge of the cover 2. The second frame 23 of the illustrated embodiment has flat parts and projections, including temporary fastening projections 26. The second frame 23 additionally or alternatively may include recesses.

The first step 12 of the base 1 functions as a reinforcement for increasing the rigidity of the base 1. Similarly, the second step 22 of the cover 2 functions as a reinforcement for increasing the rigidity of the cover 2. Thus, high rigidity can be ensured even if the base 1 and the cover 2 are made relatively thin to save space and weight.

The connecting portion 3 is a substantially plate-like part folded or curved to form a substantially straight groove and is resiliently flexible or deformable in directions to open and close the groove. The connecting portion 3 is folded along the groove when the cover 2 is placed on the base 1. As described above, the base 1 and the cover 2 are unitary with the bendable connecting portion 3. Thus, the number of parts is reduced and an operation of attaching the wiring tool 10 to the wires 9 is simplified.

The temporary fastening recesses 16 are formed on parts of the first frame 13 of the base 1 and define depressions that are open toward the cover 2. In the example shown in FIG. 1, five temporary fastening recesses 16 are formed near the wire binding portions 14 of the first frame 13 and near the connecting portion 3. The temporary fastening projections 26 are formed at the outer side of the second frame 23 of the cover 2 and are fit into the temporary fastening recesses 16 of the base 1. In the example shown in FIG. 1, five temporary fastening projections 26 are formed at positions respectively facing the five temporary fastening recesses 16.

The side surfaces of the temporary fastening projections 26 are shaped to contact the inner wall surfaces of the temporary fastening recesses 16 while being slightly compressed or deformed. In this way, the cover 2 covers the wiring portion 11 of the base 1 and is fastened to the base 1 by frictional resistance between the side surfaces of the temporary fastening projections 26 and the inner wall surfaces of the temporary fastening recesses 16 when the temporary fastening projections 26 are pushed into the temporary fastening recesses 16.

As described above, the temporary fastening recesses 16 and the temporary fastening projections 26 fit together to form a temporary fastening mechanism for fastening the cover portion 2 to the base portion 1 while covering the wiring portion 11.

The temporary fastening recesses 16 are provided on the base 1 and the temporary fastening projections 26 are provided on the cover 2 in the example shown in FIG. 1. However, a reverse or partially reverse configuration is also possible. That is, the temporary fastening recesses 16 may be provided on the cover 2 and the temporary fastening projections 26 may be provided on the base 1. Further, the temporary fastening recesses 16 and the temporary fastening projections 26 may be provided in a mixed manner on each of the base 1 and the cover 2.

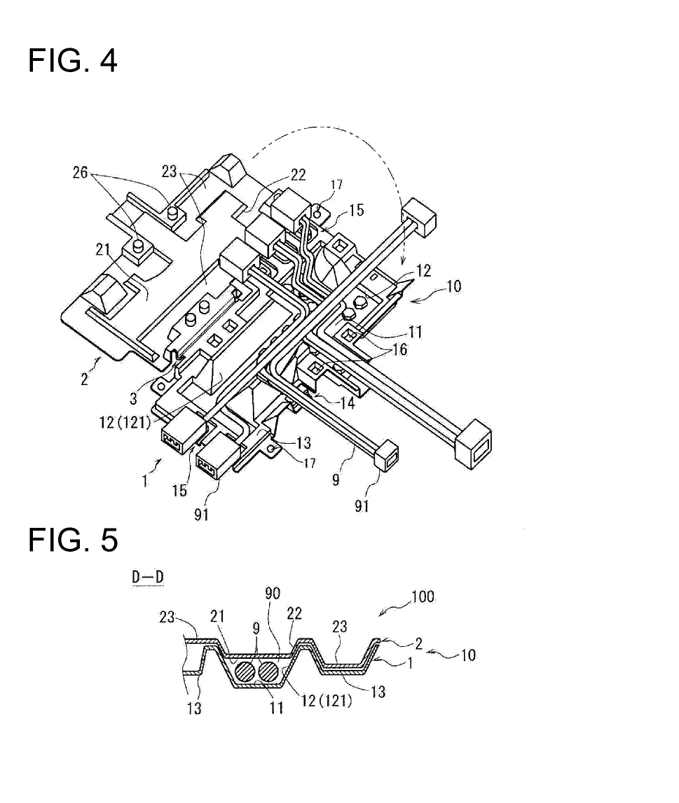

As shown in FIGS. 3 and 4, the intermediate parts of the wires 9 of the wiring harness 100 are arranged on the wiring portion 11 of the base 1. Further, connectors 91 on the ends of some wires 9 are fixed to the connector supports 15 of the base 1. Accordingly, the intermediate parts of the wires 9 connected to the connectors 91 fixed to the connector supports 15 are arranged from the wiring portion 11 to the first frame 13 via the first step 12 in the base 1.

Connectors 91 on ends of some of the other wires 9 are arranged outside the base 1 and the intermediate parts of the wires 9 connected to these connectors 91 are arranged from the wiring portion 11 to the outside of the first frame 13 via the first step 12 and the wire binding portions 14 of the first frame 13 in the base 1. These wires 9 are fixed to the wire binding portions 14 e.g. by binding belts.

As shown in FIG. 3, the base 1 and the cover 2 are fixed in an assembled state while sandwiching the intermediate parts of the wires 9 arranged on the wiring portion 11 between the wiring portion 11 and the facing wall 21. In this embodiment, parts of the temporary fastening recesses 16 and the temporary fastening projections 26 held in contact with each other are glued or welded (particularly by a device for spot heating, such as ultrasonic welding) to fix the cover 2 to the base 1. In this way, the cover 2 is held in the assembled state with the base 1 while sandwiching the intermediate parts of the wires 9 together with the base 1.

The bottom surfaces of the temporary fastening recesses 16 may contact the top surfaces of the temporary fastening projections 26 when the temporary fastening projections 26 are fit into the temporary fastening recesses 16. In this case, as shown in FIG. 3, welded portions 6 are formed at parts where the bottom surfaces of the temporary fastening recesses 16 contact the top surfaces of the temporary fastening projections 26.

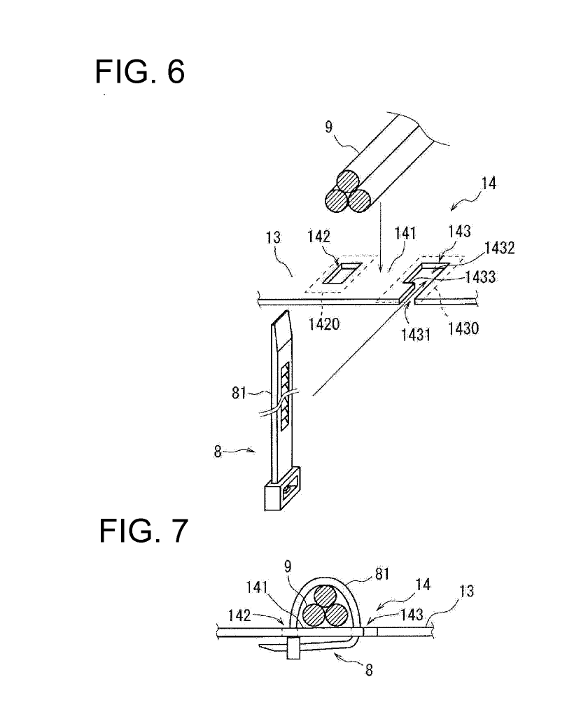

FIG. 6 is a perspective view showing a state where the wires 9 and a binding belt 8 are fixed to the wire binding portion 14 of the wiring tool 10. Further, FIG. 7 is a front view of the wire binding portion 14 to which the wires 9 are to be fixed. Note that, in FIGS. 6 and 7, the cross section of the wires 9 is shown with ends of the wires 9 omitted.

As shown in FIG. 6, the wire binding portion 14 includes a wire passage portion 141, a first belt insertion portion 1420 and a second belt insertion portion 1430 on the first frame 13. The wire passage portion 141 is a part on the first frame 13 on which the wires 9 are passed. The first belt insertion portion 1420 is adjacent to the wire passage portion 141 and the second belt insertion portion 1430 is adjacent to a side of the wire passage portion 141 opposite to the first belt insertion portion 1420.

A through hole 142 is formed in the first belt insertion portion 1420 and can receive a binding portion 81 of the binding belt 8. Note that the binding belt 8 is an example of a binding member and the binding portion 81 is a part of the binding belt 8 to be wound around a target to be bound.

The second belt insertion portion 1430 has a cut 143 that is wider than the thickness of the binding portion 81 of the binding belt 8 and extends in from the outer edge of the first frame 13. The cut 143 is in a part of the first frame 13 adjacent to the wire passage portion 141 at a side opposite to the through hole 142.

The through hole 142 and the cut 143 may be formed by performing Thompson machining on the flat resin plate before being vacuum formed.

In an example shown in FIG. 6, the cut 143 comprises a slit-like outer hole 1431 extending in from the outer edge of the first frame 13 and an inner hole 1432 communicating with the outer hole 1431 and wider than the outer hole 1431.

The inner hole 1432 faces the through hole 142 across the wire passage 141 and is widened toward the wire passage 141 from the outer hole 1431. Thus, a step 1433 is formed at a boundary between edges of the outer hole 1431 and the inner hole 1432 at the wire passage 141 side. Thus, the inner hole 1432 is widened toward the wire passage 141 from the outer hole 1431 via the step 1433.

The binding belt 8 initially is inserted from the outer hole 1431 to the inner hole 1432 in the cut 143. Thereafter, the binding belt 8 is inserted into the through hole 142 with the tip thereof in the lead and wound around the wire passage 141 and the wires 9 arranged on the wire passage 141. The binding belt 8 mounted in this manner fixes the wires 9 to the wire passage 141 of the wire binding portion 14, as shown in FIG. 7.

The edge of the through hole 142 and the step 1433 of the cut portion 143 of the wire binding portion 14 shown in FIG. 6 prevent the binding belt 8 from moving relative to the wires 9 and separating from the first frame 13 due to vibration or the like.

An alternate wire binding portion could include the wire passage 141 on the first frame 13 and through holes at the opposite sides of the wire passage 141. In this case, the two through holes are holes through which the binding belt 8 could be inserted through the two through holes for binding the wires 9 to the wire passage 141.

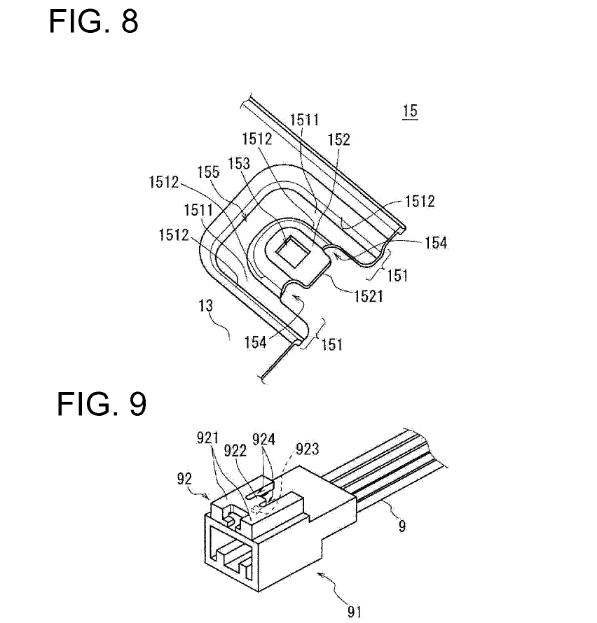

FIG. 8 is a perspective view of the connector support 15 of the wiring tool 10.

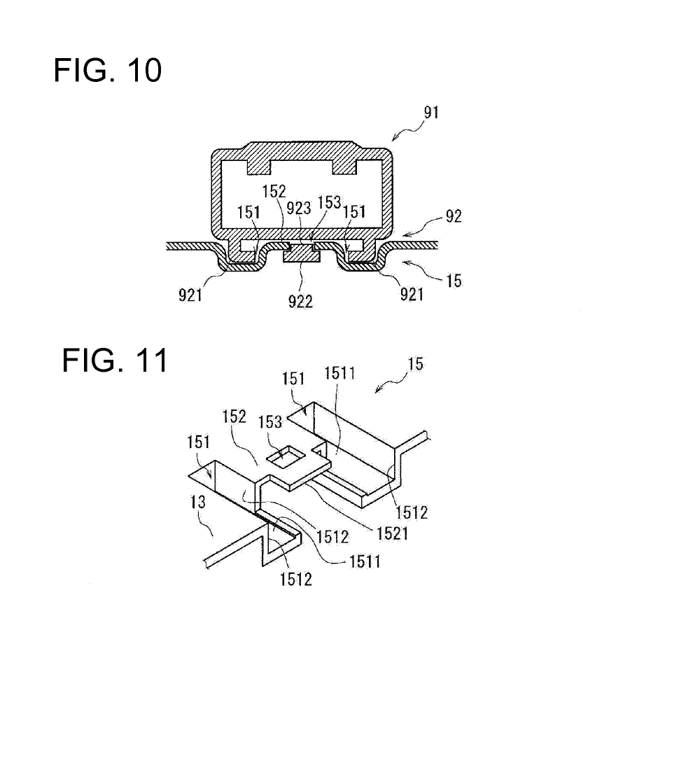

FIG. 9 is a perspective view of the connector 91 on the ends of the wires 9. FIG. 10 is a front view in section of the connector support 15 to which the connector 91 is fixed.

The connector 91 on the ends of the wires 9 is formed with a coupling 92 to be coupled to another member, such as a clamp, as shown in FIG. 9. The coupling 92 includes two parallel projections 921 with a clearance therebetween for receiving a part of a mating member to be coupled. A beam 922 bridges between the parallel projections 921 and is spaced from the outer surface of the connector 91 between the parallel projections 921. A facing projection 923 projects toward a main body of the connector 91 from a surface of the beam 922 facing the bottom surface of the main body of the connector 91.

The connector 91 shown in FIG. 9 is used widely in wiring harnesses to be mounted in automotive vehicles as disclosed e.g. in Japanese Unexamined Patent Publication No. H08-195253. Generally, a mating member of the coupling 92 includes a fitting to be fit into the clearance defined by the parallel projections 921 in the coupling 92. The fitting has a fitting hole that receives the projection 923 of the coupling 92 when the fitting is fit into the clearance between the guide rails 921 to hold the coupling 92 and the mating member in a coupled state.

A connector support 15 is formed with two parallel recesses 151 and an intermediate plate 152 between the parallel recesses 151, as shown in FIG. 8. The parallel recesses 151 of the connector support 15 define parallel grooves extending substantially straight in from the outer edge of the first frame 13 in the base 1. More specifically, each parallel recess 151 comprises a bottom plate 1511 extending substantially straight in from the outer edge of the first frame 13 and two side walls 1512 formed at both sides of the bottom plate 1511 and connected to the bottom plate 1511. The side walls 1512 form steps standing from the bottom plate 1511 at the sides of the bottom plate 1511. The parallel projections 921 in the coupling 92 of the connector 91 are to be fit into the pair of grooves formed by the parallel recesses 151.

The intermediate plate 152 of the connector support 15 is a flat plate-like part between the parallel recesses 151 and is to be inserted into a clearance between the outer surface of the main body of the connector 91 and the beam 922 of the coupling 92. The intermediate plate 152 is formed with a fitting hole 153 into which the projection 923 formed on the beam 922 is fit when the intermediate plate 152 is inserted into the clearance between the outer surface of the main body of the connector 91 and the beam 922 of the coupling 92.

The parallel projections 921 in the coupling 92 of the connector 91 are fit in the parallel recesses 151 in the connector support 15 when the connector 91 is fixed to the connector support 15, as shown in FIG. 10. Further, the intermediate plate 152 of the connector support 15 is inserted in the clearance between the outer surface of the main body of the connector 91 and the beam 922 of the coupling 92 so that the projection 923 on the beam 922 of the coupling 92 is fit in the hole 153 in the intermediate plate 152.

The parallel recesses 151 in the connector support 15 restrict movements of the connector 91 in directions perpendicular to a longitudinal direction of the grooves of the parallel recesses 151. Further, the intermediate plate 152 restricts movements of the connector 91 in a depth direction of the grooves of the pair of parallel recesses 151 by being inserted into the clearance between the outer surface of the main body of the connector 91 and the beam 922 of the coupling 92. Further, the edge of the hole 153 in the intermediate plate 152 restricts movements of the connector 91 in the longitudinal direction of the grooves of the parallel recesses 151.

Inwardly concave cuts 154 are formed adjacent the intermediate plate 152 and the parallel recesses 151 at boundary parts between both sides of the intermediate plate 152 and the parallel recesses 151. In this way, an end portion of the intermediate plate 152 at the outer edge side of the first frame 13 forms a cantilevered eave 1521.

Clearances 924 are formed between the parallel projections 921 and the beam 922 of the coupling 92 of the connector 91 shown in FIG. 9 for receiving the side walls 1512 of the parallel recesses 151. In this case, it is not essential to form the cuts 154 in the connector support 15.

The cuts 154 are formed on both sides of the intermediate plate 152 so that the intermediate plate 152 can be inserted more deeply into the clearance between the outer surface of the main body of the connector 91 and the beam 922 of the coupling 92. Thus, the intermediate plate 152 engages the beam 922 more stably and the connector 91 is less likely to separate from the connector support 15. However, it is advantageous to form the cuts 154 in the connector support 15 if the clearances 924 are not formed in the coupling 92 of the connector 91 so that the intermediate plate 152 can be inserted into the clearance between the outer surface of the main body of the connector 91 and the beam 922 of the coupling 92.

An inner recess 155 is formed at the inner side of the intermediate plate 152 of the connector support 15 and forms a groove connecting the grooves of the parallel recesses 151, as shown in FIG. 8. The inner recess 155 increases the rigidity of the connector support 15 against an external force that acts to twist the connector support 15.

As described above, the connector 91 is supported by the connector support 15 and is fixed to a part of the first frame 13. That is, the connector support 15 supports the connector 91 by engaging the coupling 92 on the outer surface of the connector 91 mounted on the ends of the wires 9. In this way, the connector 91 on the ends of the wires 9 is fixed at a specified position on the first frame 13 by a very simple operation.

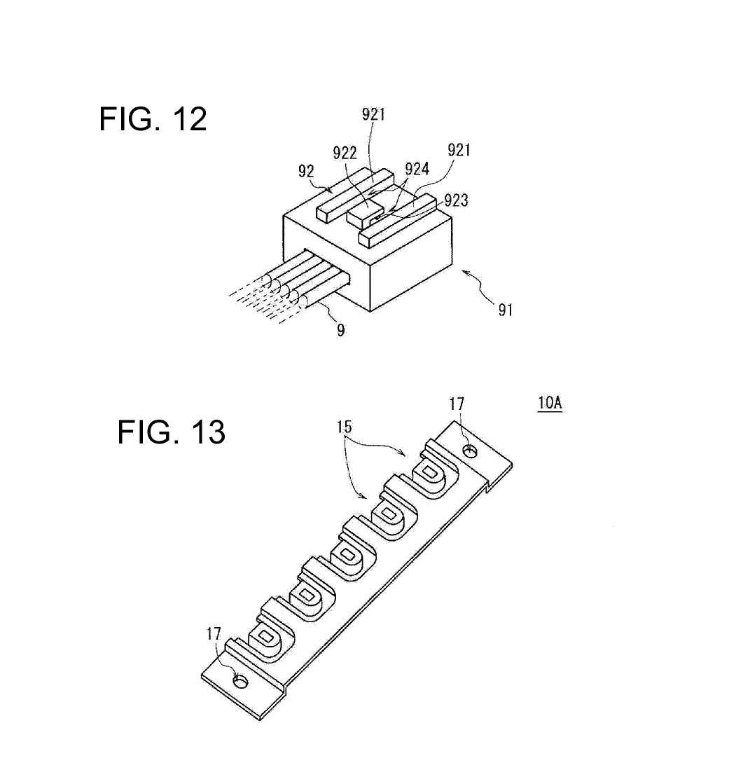

The basic structure of the connector support 15 is described with reference to FIGS. 11 and 12. FIG. 11 is a perspective view showing the basic structure of the connector support 15. FIG. 12 is a perspective view showing the basic structure of the connector 91 that can be supported by the connector support 15. That is, FIGS. 11 and 12 are perspective views diagrammatically or schematically showing only specific configurations of the connector support 15 shown in FIG. 8 and the connector 91 shown in FIG. 9. Note that, in FIGS. 11 and 12, the same or similar elements as those shown in FIGS. 8 and 9 are denoted by the same reference signs.

As shown in FIG. 12, the parallel projections 921 in the coupling 92 of the connector 91 to be supported by the connector support 15 are not necessarily in the form of guide rails defining the clearance for receiving a mating plate-like part. The connector support 15 utilizes the guide rails in the known coupling 92 formed on the connector 91 as the parallel projections 921.

Similarly, the beam 922 of the coupling 92 of the connector 91 to be supported by the connector support 15 does not necessarily bridge the parallel projections 921. The beam 922 shown in FIG. 12 is cantilevered from a supporting column projecting from the outer surface of the connector 91. The connector support 15 utilizes a projecting part in the known coupling 92 formed on the connector 91 as the beam 922.

The parallel recesses 151 in the connector support 15 shown in FIG. 11 only have to be parts which form a pair of grooves extending straight in from the outer edge of the plate-like first frame 13, and the pair of parallel projections in the coupling of the connector 91 are fit into the grooves.

The intermediate plate 152 in the connector support 15 may be a plate-like part between the parallel recesses 151 and may be formed with the hole 153 into which the facing projection 923 is fit when the intermediate plate 152 is inserted into the clearance between the outer surface of the connector and the beam of the coupling.

Further, the inner recess 155 in the connector support 15 is provided to increase the rigidity of the connector support 15. Accordingly, the inner recess 155 may not be provided, as shown in FIG. 11, if sufficient rigidity is ensured for the connector support 15 due to sufficient thickness of the plate or another structure.

The wires 9 in the wiring harness 100 are sandwiched between the base 1 and the cover 2 of the wiring tool 10. Further, the wires 9 arranged from the wiring portion 11 on the inner side to the first frame 13 on the outer side in the plate-like base 1 are fixed by the wire binding portions 14 and the connector supports 15 provided at specified positions on the first frame 13. Accordingly, parts of the wires 9 having the wiring tool 100 attached thereto and fixed by the wire binding portions 14 and the connector supports 15 are held at specified positions, and the lengths of parts of the wires at the outer sides of the parts fixed by the wire binding portions 14 and the connector supports 15 are kept constant. Thus, the shapes of the wires 9 are held by the wiring tool 10 so that the ends of the wires 9 reach a connection partner in just proportion. Further, the wires 9 are protected by the base 1 and the cover 2.

Intermediate parts of the wires 9 having the wiring tool 10 attached thereto are housed in the wiring space 90. The wiring space 90 is not partitioned and is located between the wiring portion 11 taking up the inner area of the base 1 and the facing wall 21 taking up the inner area of the cover 2. Accordingly, the wires 9 can be arranged in arbitrary paths on the wiring portion 11 of the base 1. Even if being lifted up from the wiring portion 11, the wires 9 are housed in the wiring space 90 between the wiring portion 11 and the facing wall 21 merely by placing and pressing the cover 2 against the base 1. That is, a cumbersome operation of arranging the wires 9 while pressing the wires 9 lifted up from the wiring portion 11 toward the wiring portion 11 is not necessary. In other words, an operation of attaching the wiring tool 10 to the wires 9 can be simplified.

The connector 91 on the ends of the wires 9 is fixed to the connector support 15 of the wiring tool 10 by fitting the parallel projections 921 of the coupling 92 into the grooves of the parallel recesses 15, fitting the intermediate plate 152 between the beam 922 of the coupling 92 and the outer surface of the connector 91 and fitting the facing projection 923 of the coupling 92 into the hole 153 of the intermediate plate 152.

The connector support 15 is a plate with projections, recesses and grooves and can be obtained by vacuum forming an initially flat resin plate or by injection molding using a simple mold with no sliding mechanism. Thus, man-hours and cost required for production are small.

Plural connectors 91 can be provided at a plural connector supporting portions 15 on one wiring tool 10 and can be fixed at specified positions on a supporting body, such as a panel of an automotive vehicle, substantially at one time merely by attaching one wiring tool 10 to the supporting body. Accordingly, the wiring tool 10 reduces time required for fixing the connectors 91 on the wires 9 at predetermined positions.

The respective boundary parts between sides of the intermediate plate 152 and the parallel recesses are inward. Thus, the intermediate plate 152 engages the beam 922 in the coupling 92 of the connector 91 in a more stable state and the connector 91 is less likely to separate from the connector support 15.

The inner recess 155 is formed in the connector support 15 of the wiring tool 10 and connects the pair of grooves to increase the rigidity of the connector support 15.

Members obtained by vacuum forming flat plates generally can be produced more easily and at lower cost than members obtained by resin injection molding. The wiring tool 10 including the connector support 15 preferably is obtained by vacuum forming an initially flat plate. Thus, production man-hours and production cost are reduced.

Further, the connectors 91 on the ends of the wires 9 having the wiring tool 10 attached thereto are held at fixed positions by the connector supports 15. That is, the shapes of the wires 9 are held by the wiring tool 10 so that the connectors 91 on the ends of the wires 9 reach connection partners in just proportion.

The connectors 91 are fixed at specified positions on a supporting body merely by attaching the wiring tool 10 attached to the wires 9 to the supporting body by clamps, straps, rivets, bolts or the like. Thus, the wiring tool 10 simplifies the operation of fixing the connectors 91 at specified positions on the supporting body. This effect is particularly notable since the wiring tool 10 includes the plural connector supports 15.

A connector support 18 according to a reference example to be compared with the connector support 15 is described with reference to FIG. 15. FIG. 15 is a perspective view of the connector support 18 and the connector 91.

As shown in FIG. 15, the connector support 18 includes a fitting piece 181 to be fit into the clearance between the parallel projections 921 in the coupling 92 of the connector 91. The fitting piece 181 is between a pair of cuts formed in an edge of the first frame 13. Further, the fitting piece 181 is formed with a fitting hole 182, into which the projection 923 of the coupling 92 is to be fit when the fitting piece 181 is fit into the clearance between the parallel projections 921.

The connector 91 is fixed to the connector support 18 by fitting the fitting piece 181 into the clearance between the parallel projections 921 in the coupling 92. That is, the connector support 18 is engaged with the coupling 92 formed on the connector 91 mounted on the ends of the wires 9 to support the connector 91.

The connector support 18 shown in FIG. 15 is applicable to the wiring tool 10 made of a plate-like member with projections and recesses. However, the connector support 18 supports the connector 91 only by an eave-like part of the fitting piece 181. Thus, it is difficult to ensure sufficient durability for the connector support 18 in an environment subject to vibration.

On the other hand, in the connector support 15 shown in FIG. 8, the parallel recesses 151 and the intermediate plate 152 substantially entirely support the connector 91. Further, parts between the parallel recesses 151 and the intermediate plate 152 as an intermediate part between the parallel recesses 151 are uneven and have high rigidity. Thus, sufficient durability can be ensured for the connector support 15 in an environment subject to vibration.

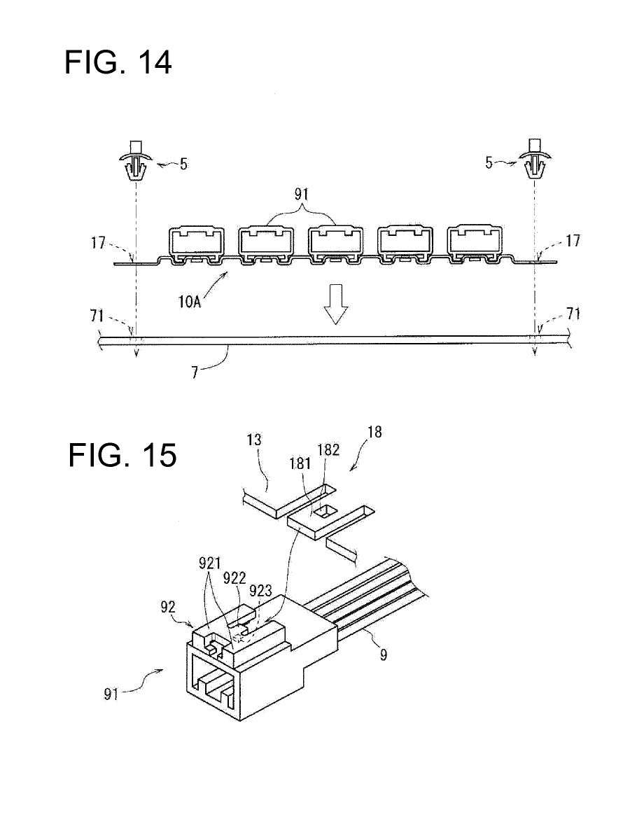

A connector supporting tool 10A according to an embodiment of the invention is described with reference to FIGS. 13 and 14. FIG. 13 is a perspective view of the connector supporting tool 10A. FIG. 14 is a front view of the connector supporting tool 10A being attached to a plate-like supporting body 7 such as a panel forming a part of the body of an automotive vehicle or an instrument panel.

The connector supporting tool 10A is a substantially plate-like resin member with projections and recesses similarly to the wiring tool 10. The connector supporting tool 10A has connector supports 15 similar to the wiring tool 10. The structure of the connector supports 15 of the connector supporting tool 10A is similar to the connector support 15 shown in FIG. 8. Although the connector supporting tool 10A shown in FIG. 14 includes five connector supports 15, it may include more or fewer connector supports 15.

The connector supporting tool 10A also has clamp holes 17 similar to the wiring tool 10. As shown in FIG. 14, the connector supporting tool 10A supports plural connectors 91 in plural connector supports 15. Further, in a state where the connector supporting tool 10A supports the plural connectors 91, clamps 5 are inserted into the clamp holes 17 of the connector supporting tool 10A and mounting holes 71 formed in the supporting body 7 to fix the connector supporting tool 10A to the supporting body 7.

The connectors 91 are fixed at specified positions of the supporting body 7 at one time merely by attaching one connector supporting tool 10A shown in FIG. 14 to the supporting body 7. Accordingly, the connector supporting tool 10A reduces the time required for fixing the connectors 91 on the wires 9 at the specified positions.

The connector supporting tool 10A shown in FIG. 13 includes the clamp holes 17, through which the clamps 5 are inserted to attach the connector supporting tool 10A to the supporting body 7. However, the connector supporting tool 10A may have a coupling structure to be coupled to another member such as the supporting body 7 or a wiring tool.

The base 1 and the cover 2 are joined unitarily formed by at least one connecting portion 3 in the wiring tool 10 described above. However, the base 1 and the cover 2 may be formed by different members that may not be connected integrally to each other.

Further, a substantially flat wiring portion 11 not formed with the projections 111 may be used in the base 1 of the wiring tool 10. Further, the wiring portion 11 of the base 1 may be formed with one projections and/or grooves substantially continuous in a reticular or net-like pattern. Such projections or grooves also achieve an effect of increasing the rigidity of the wiring portion 11.

The base 1 and the cover 2 may be obtained by resin injection molding. However, the wiring tool 10 and the connector supporting tool 10A preferably are plates with projections and recesses only in a vertical direction (linear direction) and are obtained easily by vacuum forming plate-like resin members. Accordingly, in terms of production man-hours and production cost, the wiring tool 10 and the connector supporting tool 10A preferably are obtained by vacuum forming initially flat plates.

What is claimed is:

1. A wiring harness, comprising:
at least one connector (91) mounted on ends of respective wires (9) and having an outer surface, a coupling (92) including two substantially straight parallel projections (921) projecting from the outer surface, a beam (922) between the parallel projections (921) and spaced from the outer surface, and a facing projection (923) projecting from the beam (922) toward the outer surface; and
a connector supporting tool (10) with at least one connector support (15; 18) having an outer edge and two parallel grooves (151) extending substantially straight in from the outer edge, the parallel projections (921) of the coupling (92) of the connector (91) being fit into the parallel grooves (151), an intermediate plate (152) between the parallel grooves (151) and formed with a hole (153), the facing projection (923) being fit in the hole (153) when the intermediate plate (152) is inserted into a clearance between the outer surface of the connector (91) and the beam (922) of the coupling (92).

2. The connector supporting assembly of claim 1, wherein the connector support (15; 18) has at least one projection and at least one recess, the parallel grooves (151) extending straight in from the outer edge of the plate-like member.

3. The connector supporting assembly of claim 1, wherein boundary parts between sides of the intermediate plate (152) and the parallel grooves (151) are cut inward.

4. The connector supporting assembly of claim 1, further comprising an inner recess (155) connecting ends of the parallel recesses (151) inward of the intermediate plate (152).

5. The connector supporting assembly of claim 1, wherein the connector supporting tool (10A) is made by vacuum forming an initially flat resin plate.

6. A wiring tool (10), comprising:
a plate-like wiring portion (11) at least partly defining a wiring space (90);
a frame (13) outward of the wiring portion (11) and defining an outer edge of the wiring tool (10); and
at least one connector support (15; 18) formed on a part of the frame (13), the connector support (15; 18) being formed with two parallel recesses (151) extending substantially straight in from the outer edge of the wiring tool (10), an intermediate plate (152) between the parallel recesses (151) and a locking hole (153) in the intermediate plate (152), whereby a wire (9) can be held in the wiring space (90) and a connector mounted to an end of the wire (9) can be engaged with the parallel recesses (151) and the locking hole (153) of the connector support (15; 18).

7. The wiring tool of claim 6, wherein boundary parts between both sides of the intermediate plate (152) and the parallel recesses (151) are cut inward.

8. The wiring tool of claim 6, wherein an inner recess (155) connects ends of the parallel recesses (151) at an inner side of the intermediate plate (152).

9. The wiring tool of claim 8, wherein the connector supporting tool (10A) is formed with projections and recesses by vacuum forming an initially flat resin plate.

10. A wiring harness (100), comprising:
wires (9) and at least one connector (91) mounted on ends of the wires (9), the connector (91) having a coupling (92) with two substantially straight parallel projections (921) projecting from an outer surface of the connector (91), a beam (922) between the projections (921) and spaced from the outer surface of the connector (91), and a facing projection (923) projecting from the beam (922) toward the outer surface; and
the wiring tool (10) of claim 6.
